(19) United States
(12) Patent Application Publication
(10) Pub. No.: US 2014/0102480 A1
(43) Pub. Date: Apr. 17, 2014

(54) METHOD AND APPARATUS FOR CLEANING ROCK CORES

(71) Applicant: SCHLUMBERGER TECHNOLOGY CORPORATIO, Sugar Land, TX (US)

(72) Inventors: Andrew E. Pomerantz, Lexington, MA (US); Calvin Boerigter, Minneapolis, MN (US); Steven Modzelewski, Conway, AR (US)

(73) Assignee: SCHLUMBERGER TECHNOLOGY CORPORATION, Sugar Land, TX (US)

(21) Appl. No.: 13/652,146

(22) Filed: Oct. 15, 2012

(51) Int. Cl. B08B 3/08

(52) U.S. Cl. 134/18; 134/58 R

(57) ABSTRACT

A method and apparatus for cleaning a rock core sample loads the sample into a cell where it is supported within an interior chamber of the cell. For at least one interval of time, the sample is soaked with a liquid phase solvent pressurized at elevated pressure and temperature without any flow of the liquid phase solvent into, through, and out of the chamber. The liquid phase solvent is then allowed to drain from the cell. The cell can include a fluid inlet and outlet that are both in fluid communication with the chamber. A controller can be used to control at least one parameter related to the soaking. The at least one parameter can be selected from the group consisting of i) the duration of the time interval, ii) pressure of the liquid phase solvent during the time interval, and iii) temperature of the cell during the time interval.

### BACKGROUND

1. Field

The present application relates to methods and apparatus for cleaning hydrocarbons from rock core samples.

2. Related Art

Cleaning a rock core to remove hydrocarbons from the rock core is an essential part of routine and special rock core analysis. Such rock core cleaning in typically accomplished by Soxhlet extraction, which is effective but time consuming. Soxhlet extraction allows for repeated, automatic washing of the rock core in purified solvent at atmospheric pressure and at a temperature between room temperature and the boiling point of the solvent. This technique is known to remove almost all hydrocarbons in typical rock cores without damaging the rock cores. However, it is quite slow, typically requiring weeks to months.

Other techniques have been proposed or used to clean rock cores. For example, U.S. Pat. No. 4,687,523 describes a method where hot solvent is pumped into the rock core and then volatilized to expel solid contaminants.

In another example, U.S. Pat. No. 2,617,719 describes a method where a mixture of gases and liquids is pumped into the rock core and then volatilized to expel liquid and solid contaminants.

In yet another example described at http://www.coretest.com/product_detail.php?p_id=132), solvent at a temperature between room temperature and the boiling point of the solvent is forced to flow through the rock core using a centrifuge.

In still another example described at http://www.coretest.com/product_detail.php?p_id=131), a mixture of solvent and CO₂ is pressurized into the rock core.

In yet another example described at http://www.vinci-technologies.com/products-explo.aspx?IDR=82293&idr2=82573&IDM=536754, solvent at elevated temperature and pressure is pumped though a core rock.

The methods that pump solvent (and possibly other fluids) through the rock core can lead to fines migration, which is the movement of fine particles or similar materials within the rock core due to drag forces during the cleaning process. Fines migration can lead to the fine particles bridging the pore throats of the rock core, and thus can unwantedly affect properties of the cleaned rock core, such as porosity and permeability, and introduce errors in the analysis of such properties.

### SUMMARY

A method and apparatus for cleaning a rock core sample loads the rock core sample into a cell where the sample is supported within an interior chamber of the cell. For at least one interval of time, the rock core sample supported within the interior chamber is soaked with a liquid phase solvent pressurized at elevated pressure and temperature above ambient conditions without any flow of the liquid phase solvent into, through, and out of the interior chamber of the cell. After expiration of the interval of time, the liquid phase solvent is allowed to drain from the cell.

Advantageously, the pressurized high temperature no-flow soaking provides for efficient and effective rock core cleaning while reducing the likelihood of fines (small particles) migrating through the rock core sample and possibly getting stuck in the pore throats (bridging), thereby reducing the permeability of the rock core sample.

The cell can include a fluid inlet and a fluid outlet that are both in fluid communication with the interior chamber. The cell can be configured to allow for fluid flow into the interior chamber via the fluid inlet, through the interior chamber, and out the interior chamber via the fluid outlet. The fluid inlet and fluid outlet of the cell can be connected to a flow line with a first isolation valve disposed upstream of the fluid inlet of the cell and a second isolation valve disposed downstream of the fluid outlet of the cell. After connecting the fluid inlet and fluid outlet of the cell to the flow line, the second isolation valve can be closed while pumping the liquid phase solvent into the flow line under pressure in order to pressurize the liquid phase solvent in the interior chamber of the cell. Both the first and second isolation valves can be closed during the interval of time for soaking the rock core sample.

A plurality of rock core samples can be processed in parallel to allow for soaking of the plurality of rock core samples supported within the interior chambers of respective cells during the at least one interval of time.

In one embodiment, a controller can be used to control at least one operational parameter related to the soaking of the rock core sample. The at least one operational parameter can be selected from the group consisting of i) the duration of the interval of time, ii) pressure of the liquid phase solvent during the interval of time, and iii) temperature of the cell during the interval of time.

One embodiment of an apparatus for cleaning a rock core sample includes a flow line with connectors that provide for sealable coupling to the fluid inlet port and fluid outlet port of a cell that holds the rock core within an interior chamber of the cell. The flow line includes an electrically-controlled first isolation valve operably disposed upstream of the cell, an electrically-controlled second isolation valve operably disposed downstream of the cell, and a pressure sensor for measuring fluid pressure in the flow line. An electrically-controlled heater block is provided for heating the cell. An electrically-controlled pump is fluidly coupled to the flow line and configured to supply a liquid phase solvent under pressure to the flow line. A controller is operably coupled to the first and second isolation valves, the pressure sensor, the pump and the heater block. The controller is configured to control operation of the first and second isolation valves, the pressure sensor, the pump and the heater block during at least one interval of time in order to soak the rock core sample supported within the interior chamber of the cell with a liquid phase solvent at an elevated pressure and temperature above ambient conditions without any flow of the liquid phase solvent into, through, and out of the interior chamber of the cell. The controller is further configured to control operation of the second isolation valve after expiration of the interval of time to allow the liquid phase solvent to drain from the cell.

The cell can be configured to allow for fluid flow into the interior chamber via the fluid inlet and through the interior chamber and out the interior chamber via the fluid outlet.

The controller of the apparatus can be configured to control at least one operational parameter related to the soaking of the rock core sample. The at least one operational parameter can be selected from the group consisting of i) the duration of the interval of time, ii) pressure of the liquid phase solvent during the interval of time, and iii) temperature of the cell during the interval of time. The apparatus can further include user input means for interacting with the control to specify the at least one operational parameter.

The apparatus can include a plurality of flow lines for processing to plurality of rock core samples in parallel to allow for soaking of the plurality rock core samples supported within the interior chambers of respective cells during the at least one interval of time.

In certain embodiments of the method and apparatus, the at least one interval of time has a cumulative duration less than 10 minutes.

In yet another embodiment of the method and apparatus, the pressure of the liquid phase solvent during the interval of time can be between 80 bar and 100 bar, and the temperature of the cell during the interval of time can be at or near 150° C. The liquid phase solvent can be selected from the group consisting of a hydrocarbon solvent (such as toluene, benzene, pentane, hexane, or heptane), a chlorinated solvent (such as methylene chloride, dichloromethane or chloroform), or a polar solvent (such as acetone or methanol), and mixtures thereof.

### BRIEF DESCRIPTION OF THE DRAWINGS

FIG. 1 is a schematic cross-sectional view of a soaking cell for holding a rock core sample for cleaning purposes in accordance with the present application.

FIG. 2 is a high level schematic block diagram of an apparatus for cleaning one or more rock core samples in accordance with the present application.

FIGS. 3A and 3B, collectively, are a flow chart describing operations of the apparatus of FIG. 2 for cleaning one or more rock core samples in accordance with the present application.

FIG. 4 is a graph illustrating pre-clean and post-clean porosity values for a number of rock core samples cleaned by the methodology of FIGS. 3A and 3B under different operating conditions.

FIG. 5 is a graph illustrating porosity of a rock core sample cleaned by the methodology of FIGS. 3A and 3B over time.

FIG. 6 is a graph illustrating mass removed from a rock core sample cleaned by the methodology of FIGS. 3A and 3B over time.

### DETAILED DESCRIPTION

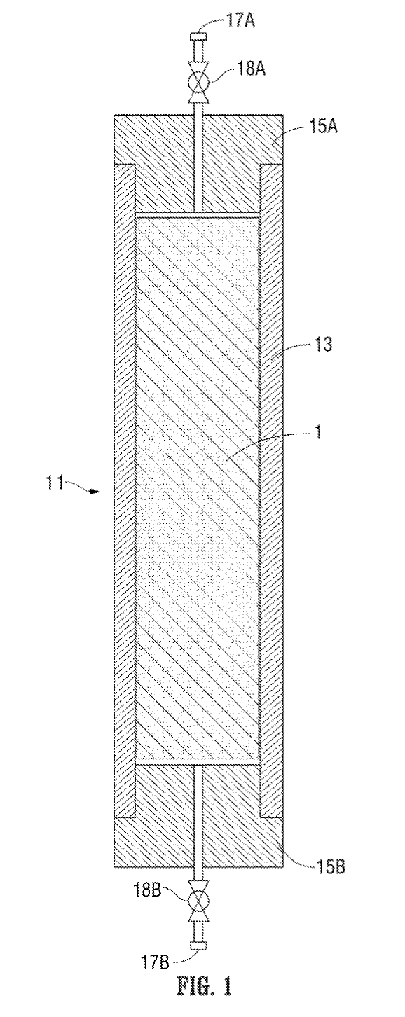

FIG. 1 is a schematic view of an exemplary soaking cell 11 that houses a rock core sample 1. The cell 11 includes a tubular vessel 13 whose interior space receives the rock core sample 1. End caps 15A, 15B are secured to opposed ends of the tubular vessel 13. One end cap 15A includes a fluid inlet port 17A that is in fluid communication with the interior space of the vessel 13 for the supply of solvent to the core sample 1 therein. The opposite end cap 15B includes a fluid outlet port 17B that communicates with the interior space of the vessel 13 for the discharge of solvent and possibly fluids extracted from the core sample 1 held within the interior space of the vessel 13. The end caps 15A, 15B can be removably secured to the respective ends of the tubular vessel 13 by a threaded interface or other suitable mechanical means. The core sample 1 is loaded into the cell 11 for cleaning as shown. The vessel 13 is configured to hold the rock core sample 1 and solvent in the interior space of the vessel 13 under elevated temperature and pressure during cleaning as described herein. The fluid inlet port 17A and the fluid outlet port 17B can include a respective stop cock or other suitable valve 18A, 18B that provides for isolation of the interior space of the vessel 13, for example while loading the cell into the heater block 101 and connecting the fluid inlet port 17A and the fluid outlet port 17B of the cell 11 to the flow line of the apparatus as described below. Once the fluid inlet port 17A and the fluid outlet port 17B of the cell 11 are connected to the respective flow line of the apparatus, the isolation valves 18A, 18B of the cell 11 can be opened for the cleaning operation.

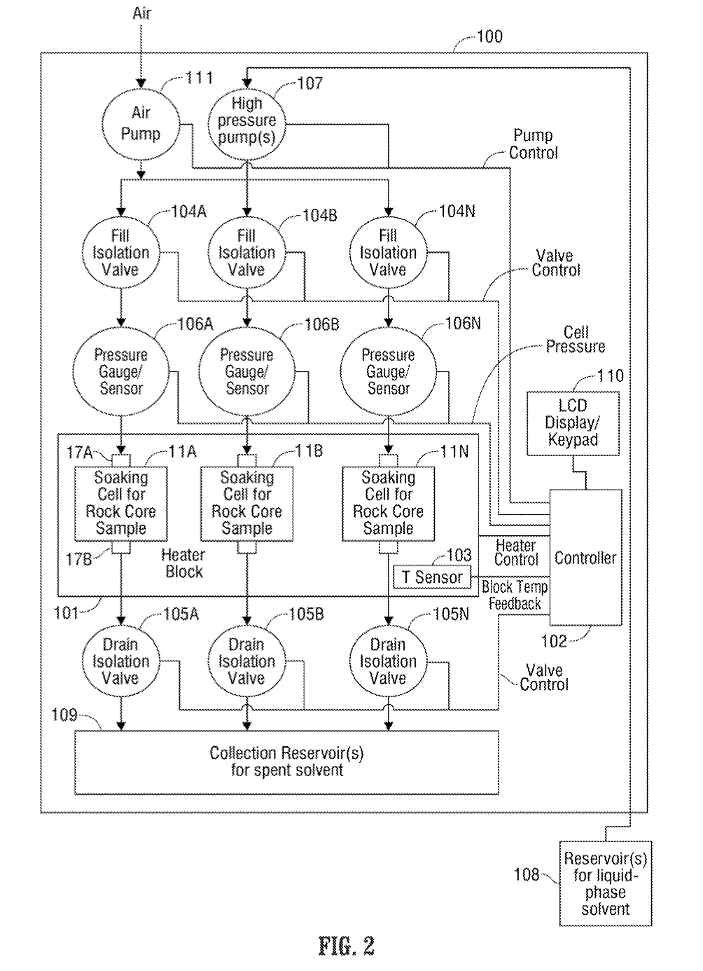

FIG. 2 is schematic diagram of an apparatus 100 for cleaning one or more rock core samples according to the present application. The apparatus 100 includes a heater block 101 that receives the soaking cell(s) of FIG. 1 with the core samples disposed therein (labeled 11A, 11B . . . 11N). With the soaking cell(s) loaded into heater block 101, the cells are thermally coupled to the heater block 101 to allow for heating of the soaking cells by the heater block 101. Controller 102 is configured to control the heating temperature of the heater block 101 in order to heat the cells 11A, 11B . . . 11N to a desired temperature. In particular, the temperature of the heater block 101 is sensed by a temperature sensor 103 and communicated as a block temperature signal to the controller 102 to allow for feedback control of the temperature of the heater block 101.

The fluid inlet port 17A and the fluid outlet port 17B of each respective soaking cell 11 is sealably connected to a flow line that includes an electrically-controlled fill isolation valve and an electrically-controlled drain isolation valve. Thus, soaking cell 11A is sealably connected to a flow line that includes fill isolation valve 104A and drain isolation valve 105A, soaking cell 11B is sealably connected to a flow line that includes fill isolation valve 104B and drain isolation valve 105B, etc. The respective fill isolation valves 104A, 104B, . . . 104N operate under the control of the controller 102 to selectively isolate the corresponding flow lines from one or more upstream components (i.e., high pressure pump 107). The respective drain isolation valves 105A, 105B, . . . 105N operate under the control of the controller 102 to selectively isolate the corresponding flow lines from one or more downstream components (e.g., one or more collection reservoirs 109). A pressure gauge and pressure sensor (106A, 106B, . . . 106N) are part of each respective flow line. The pressure sensors measure the pressures of the corresponding flow lines and communicate corresponding pressure signals to the controller 102 to allow for feedback control of the pressures of the flow lines (including the internal pressures of the soaking cells that are part of the flow lines).

The apparatus 100 further includes an electrically-controlled high pressure pump 107. The inlet of the pump 107 is fluidly coupled to a reservoir 108 of liquid phase solvent by tubing. The discharge of pump 107 is fluidly coupled to the respective fill isolation valves 104A, 104B, . . . 104N of the flow lines by a tubing network. The controller 102 is configured to control operation of the pump 107 via pump control signals supplied to the pump 107 in order to supply liquid phase solvent to the flow lines under pressure.

Spent solvent and possibly fluid extracted from the core sample during the cleaning operation flow downstream through the drain isolation valves 105A, 105B, . . . 105N to one or more collection reservoirs 109.

The controller 102 interfaces to user input/output devices 110 such as an LCD display and keypad. The controller 102 is configured to cooperate with the user input/output devices 110 to interact with a user to specify certain parameters of the cleaning operation and initiate activation of the controller-managed core cleaning operation as described herein.

The apparatus 100 can optionally include a pump 111 that is configured to pump in air or other fluids through the flow lines in order to dry the rock core samples held within the cells 11A, 11B . . . 11N as part of the cleaning process. The pump 111 can be electrically controlled by pump control signals supplied by the controller 102 as shown.

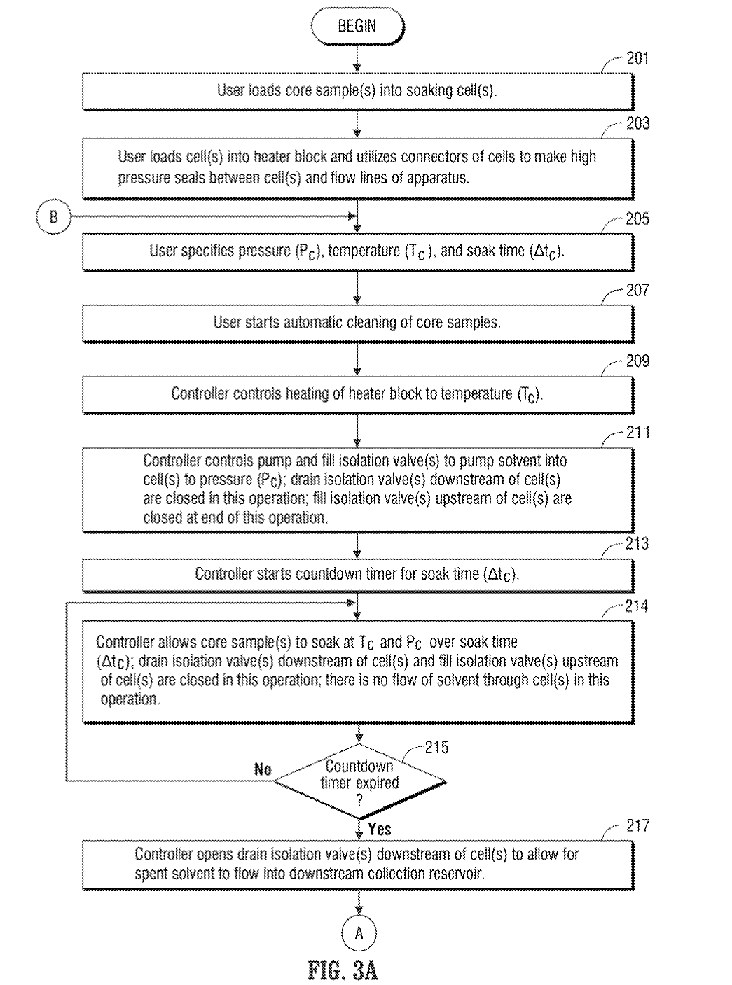

The operation of the apparatus 100 in cleaning the core sample(s) that are housed within the soaking cells 11A, 11B . . . 11N of FIG. 2 is illustrated in FIGS. 3A and 3B. The operations begin in block 201 where the user loads one or more core samples into corresponding soaking cell(s) as described above.

In block 203, the user loads the cells(s), each with a core sample disposed therein, into the heater block 101 and connects the fluid inlet port 17A and the fluid outlet port 17B of each respective cell to a corresponding flow line of the apparatus, thus making a high pressure seal between the respective cell and the rest of the system. Once the fluid inlet port 17A and the fluid outlet port 17B of the respective cell are connected to the corresponding flow line of the apparatus, the isolation valves 18A, 18B of the cell, if used, can be opened for the cleaning operation.

In block 205, the user interacts with the user input/output devices 110 of the apparatus 100 to specify a pressure P_{c}, a temperature T_{c}, and a soak time Δt_{c} for the automatic cleaning process of the core sample(s) disposed within the cell(s) 11. Alternatively, one or more of these parameters can be stored in the memory of the controller 102 and used as a predetermined fixed parameter of the automatic cleaning process.

In block 207, the user interacts with the user input/output devices 110 of the apparatus 100, for example by pressing a start button, to initiate the automatic cleaning process of the core sample(s) disposed within the cell(s) 11.

The automatic cleaning process of the core sample(s) disposed within the cell(s) involves a sequence of automatic operations managed by the controller 102 as set forth in blocks 209 to 221 described below.

In block 209, the controller 102 controls the heating of the heater block 101 such that the heater block 101 is heated to the temperature T_{c} specified by the user in block 205. During this operation, the temperature of the heater block 101 is sensed by the temperature sensor 103 and communicated as a block temperature signal to the controller 102 to allow for feedback control of the temperature of the heater block 101. During this operation, the cell(s) are heated to a temperature at or near the temperature T_{c} specified by the user in block 205.

In block 211, the controller 102 controls the pump 107 and the fill isolation valve(s) 104 such that solvent is pumped into the flow lines (and thus into the cell(s)) to the pressure P_{c} specified by the user in block 205. During this operation, the pressure sensors of the respective pressure gauge/sensors 106 measure the pressures of the corresponding flow lines and communicate the corresponding pressure signals to the controller 102 to allow for feedback control of the pressures of the flow lines (including the pressures of the cell(s) that are part of the flow lines). The drain isolation valve(s) 105 disposed downstream of the cell(s) 11 are closed in this operation. During this operation, the controller 102 controls the heating of the heater block 101 to maintain the temperature of the cell(s) at or near the temperature T_{c} specified by the user in block 205. The fill isolation valve(s) 104 disposed upstream of the cell(s) are closed when the pressure in the corresponding flow line(s) reaches the pressure P_{c}. After pressurizing the flow lines, the operations continue to block 213.

In block 213, the controller 102 starts a countdown timer for the soak time Δt_{c} as specified by the user in block 205 and continues to block 214.

In block 214, the controller 102 allows the core sample(s) disposed in the cell(s) to soak at the temperature T_{c} and the pressure P_{c} over the soak time Δt_{c}. The fill isolation valve(s) 104 disposed upstream of the cell(s) and the drain isolation valve(s) 105 disposed downstream of the cell(s) are closed such that there is no flow of solvent through the cell(s) in this operation. During this operation, the controller 102 controls the heating of the heater block 101 to maintain the temperature of the cell(s) at or near the temperature T_{c} specified by the user in block 205.

In block 215, the controller 102 determines if the countdown timer (e.g., the soak time Δt_{c}) has expired. If not, the controller 102 returns to block 214 to continue waiting for the expiration of the countdown timer (the soak time Δt_{c}). If the countdown tinier (the soak time Δt_{c}) has expired, the operations of the controller 102 continue to block 217.

In block 217, the controller 102 opens the drain isolation valve(s) 105 downstream of the cell(s) to allow for the spent solvent to flow into the downstream collection reservoir 109. The drain isolation valve(s) 105 are preferably left open until the pressure of the respective flow line(s) for the cell(s) falls below a predetermined threshold pressure.

In optional block 219, the controller 102 can repeat part or all of blocks 205 to 217 for a number of times. The temperature T_{c}, the pressure P_{c}, the soak time Δt_{c} and/or the solvent can be varied in each iteration. If such iterations are complete, the controller 102 continues to block 221. If not, the controller 102 repeats the necessary operations of blocks 205 to 217.

In block 221, the controller 102 can optionally activate the pump 111 and open the fill isolation valve(s) 104 and drain isolation valve(s) 105 to blow air or other fluids through the flow line(s) and corresponding cell(s) for a predetermined timer period in order to dry the core sample(s) disposed in the cell(s) 11 and accelerate solvent evaporation.

In block 223, the automatic core cleaning process is complete and the user disconnects the fluid inlet port 17A and the fluid outlet port 17B of each respective cell(s) from the corresponding flow line of the apparatus 100, thus breaking the high pressure seal between the respective cell(s) and the rest of the system. The user then unloads the cell(s) from the heater block 101.

In block 225, the user removes the cleaned core sample(s) from the respective cell(s) for subsequent analysis.

Note that the pressure P_{c} for the automatic core cleaning process as described above is preferably in a range between 80 bar and 100 bar. Pumps suitable for pressurizing, the flow line(s) of the apparatus 100 to such high pressures include pumps for high performance liquid chromatography applications and the like. Also note that the temperature T_{c} for the automatic core cleaning process as described above is preferably at or near 150° C. Higher temperatures may decrease the required soak time for proper cleaning but risk damage to the core sample(s).

The liquid phase solvents used for the automatic core cleaning process as described above can include a hydrocarbon solvent (such as toluene, benzene, pentane, hexane, or heptane), a chlorinated solvent (such as methylene chloride, dichloromethane, or chloroform), or a polar solvent (such as acetone or methanol). Chlorinated solvents are preferred over polar solvents. The solvent can also be a blend of one or more chlorinated solvents with one or more polar solvents.

Note that the pressure P_{c} and temperature T_{c} and solvent are selected such that the solvent is in the liquid phase inside the respective cell(s) during the soak operations of block 214. The high temperature T_{c} typically exceeds the normal boiling point of the solvent (i.e., the boiling point of the solvent at atmospheric pressure at sea level).

The pressure P_{c}, temperature T_{c}, and the solvent are also preferably selected for optimal gentleness in order to minimize alterations of one or more rock properties (such as porosity, grain density, formation factor, and NMR relaxation time) of the respective core sample(s) by the cleaning process carried out by the apparatus 100 as described herein.

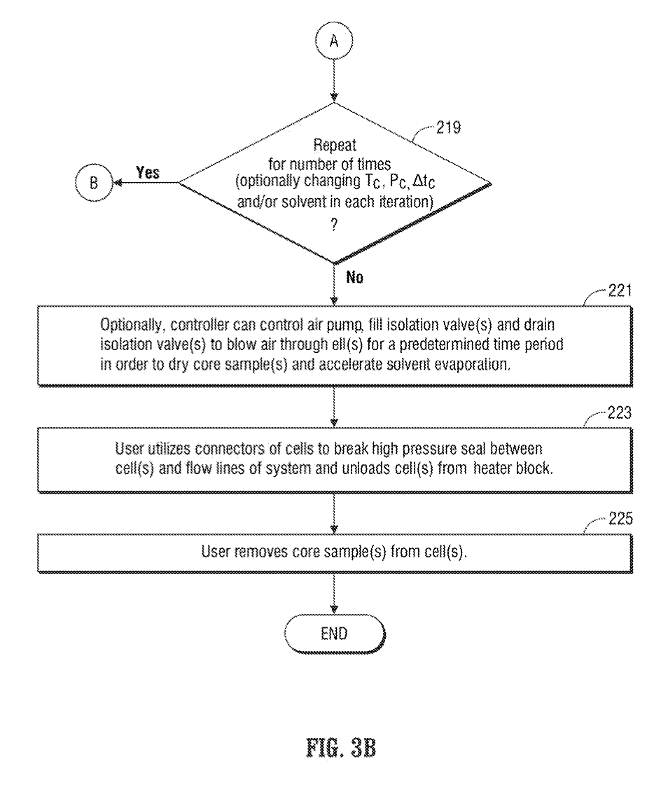

FIG. 4 shows an exemplary graph of measured pre-clean porosity and post-clean porosity for a number of quarry rock core samples cleaned by the cleaning process described herein. The core samples were not initially “dirty” so as to facilitate testing for cleaning gentleness. The graph shows values (solid triangles) for three different core samples cleaned by a chlorinated solvent (chloroform). The graph also shows values (solid squares) for four different core samples cleaned by toluene. For each core sample, the cleaning process employed five cycles of a soak time Δt_{c} of 2 minutes at a pressure P_{c} of 80 bar and a temperature T_{c} at or near 150° C. The four core samples cleaned by toluene included a Portland Red sandstone (37% quartz, 21% calcite, 25% kaolinite), an Indiana limestone (99% calcite), a Silurian Dolomite (98% dolomite), and a Brady shale (20% quartz, 30% feldspar, 25% glauconite, 10% chlorite). The three core samples cleaned by chloroform included a Portland Red sandstone (37% quartz, 21% calcite, 25% kaolinite), an Indiana limestone (99% calcite), and a Silurian Dolomite (98% dolomite). In FIG. 4, the 1:1 line is shown as a solid line and the dashed lines indicate the industry standard acceptable errors in porosity measurements, as defined in Thomas and Pugh, “A. Statistical Analysis of the Accuracy and Reproducibility of Standard Core Analysis”, The Log Analyst (1989), pp. 71-77. The measured points show that the cleaning process as described herein does not alter porosity beyond accepted error and is thus sufficiently gentle. Similar measurements can be made for grain density, formation factor, and NMR relaxation of a number of core samples to test for gentleness of the cleaning procedure.

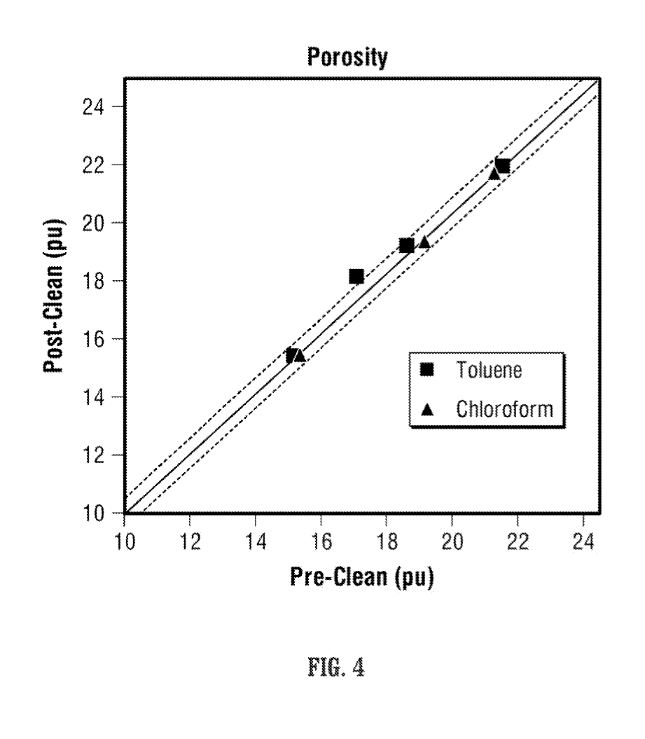

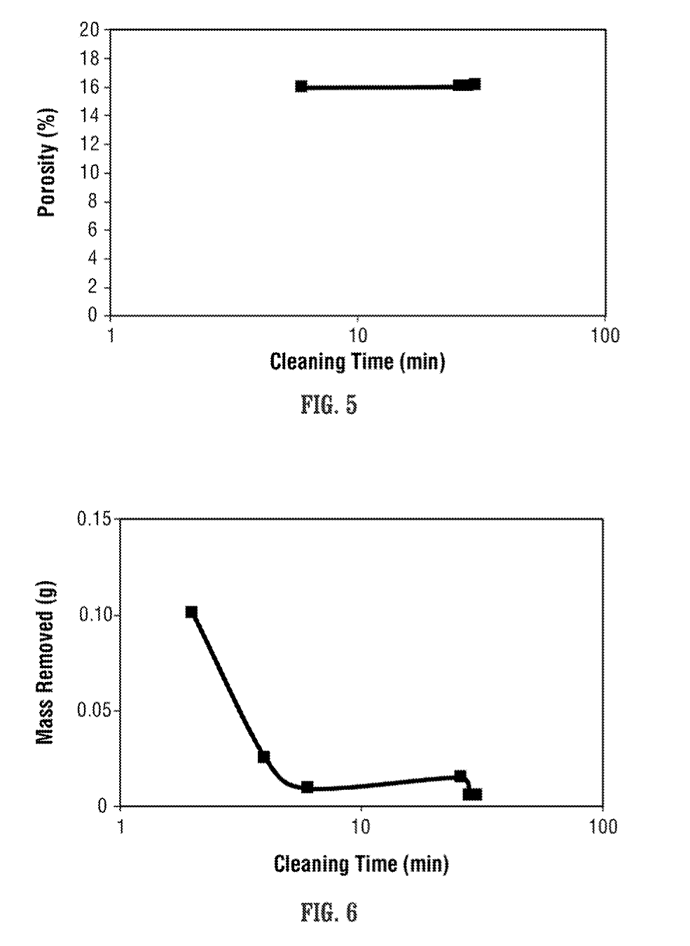

The soak time Δt_{c} (and/or number of cycles of soak time) for the cleaning process can be assessed by starting with an oil-saturated rock core sample, cleaning the rock core sample with the cleaning process (possibly with different parameters such pressure P_{c}, temperature T_{c}, and solvent), and measuring properties (such as mass removed and porosity) after different soak times Δt_{c} (or number of cycles of soak time). The desired soak time Δt_{c} (and/or number of cycles of soak time) corresponds to those conditions at which further cleaning yields no further significant change in such core properties. FIGS. 5 and 6 show the porosity and the removed mass, respectively, of a rock core sample cleaned with a cleaning process employing a pressure P_{c} of 80 bar and a temperature T_{c} at or near 150° C. and a chlorinated solvent (chloroform) for an incremental number of cycles with a soak time Δt_{c} of two minutes for each cycle. The cleaning time of the x-axis of each respective graph represents the accumulated soak time for the core sample over the two minute soak cycles. These graphs demonstrate that the core cleaning process is capable of cleaning the core sample to a point where there is no further significant change in relevant core properties in an accumulated soak time less than 10 minutes, which corresponds to five two minute soak cycles.

The rock core cleaning methodology and apparatus as described herein allows for the rock core sample to soak in a liquid phase solvent at elevated temperature and pressure without any flow of liquid phase solvent through the rock core sample during the soak. Such no-flow soaking reduces the likelihood of fines (small particles) migrating through the rock core sample and possibly getting stuck in the pore throats (bridging), thereby reducing the permeability of the rock core sample.

There have been described and illustrated herein several embodiments of a method and apparatus for cleaning a rock core sample. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its scope as claimed.

What is claimed is:

1. A method of cleaning a rock core sample comprising:
loading the rock core sample into a cell, wherein the rock core sample is supported within an interior chamber of the cell;
for at least one interval of time, soaking the rock core sample supported within the interior chamber of the cell with a liquid phase solvent pressurized above ambient pressure at a temperature elevated above ambient temperature without any flow of the liquid phase solvent into, through, and out of the interior chamber of the cell; and
after expiration of the interval of time, allowing the liquid phase solvent to drain from the cell.

2. A method according to claim 1, wherein the cell includes a fluid inlet and a fluid outlet that are both in fluid communication with the interior chamber, wherein the cell is configured to allow for fluid flow into the interior chamber via the fluid inlet, through the interior chamber, and out of the interior chamber via, the fluid outlet.

3. A method according to claim 1, further comprising using a controller to control at least one operational parameter related to soaking the rock core sample, wherein the at least one operational parameter is selected from the group consisting of i) the duration of the interval of time, ii) pressure of the liquid phase solvent during the interval of time, and iii) temperature of the cell during the interval of time.

4. A method according to claim 3, further comprising using the controller to change at least one operational parameter related to soaking the rock core sample and again soaking the rock core sample supported within the interior chamber of the cell with a liquid phase solvent pressurized above ambient pressure at a temperature elevated above ambient temperature without any flow of the liquid phase solvent into, through, and out of the interior chamber of the cell.

5. A method according to claim 1, wherein a plurality of rock core samples are processed in parallel to allow for soaking of the plurality rock core samples supported within the interior chambers of respective cells during the at least one interval of time.

6. A method according to claim 1, wherein the at least one interval of time has a cumulative duration less than 10 minutes.

7. A method according to claim 1, wherein the pressure of the liquid phase solvent during the interval of time is between 80 bar and 100 bar.

8. A method according to claim 1, wherein the temperature of the cell during the interval of time is at or near 150° C.

9. A method according to claim 1, wherein the cell is thermally coupled to a heater block to provide for controlled heating of the cell.

10. A method according to claim 1, wherein the cell has a fluid inlet and a fluid outlet that are both fluidly coupled to the interior chamber of the cell.

11. A method according to claim 1, further comprising connecting the fluid inlet and fluid outlet of the cell to a flow line with a first isolation valve disposed upstream of the fluid inlet of the cell and a second isolation valve disposed downstream of the fluid outlet of the cell.

12. A method according to claim 11, wherein after connecting the fluid inlet and fluid outlet of the cell to the flow line, the second isolation valve is closed while pumping the liquid phase solvent into the flow line under pressure in order to pressurize the liquid phase solvent in the interior chamber of the cell.

13. A method according to claim 12, wherein both the first and second isolation valves are closed during the interval of time for soaking the rock core sample.

14. A method according to claim 1, wherein the liquid phase solvent is selected from the group consisting of a hydrocarbon solvent, a chlorinated solvent, a polar solvent, and mixtures thereof.

15. A method according to claim 1, further comprising:
for at least one interval of time, soaking the rock core sample supported within the interior chamber of the cell with a different liquid phase solvent pressurized above ambient pressure at a temperature elevated above ambient temperature without any flow of the liquid phase solvent into, through, and out of the interior chamber of the cell; and
after expiration of the interval of time, allowing the different liquid phase solvent to drain from the cell.

16. An apparatus for cleaning a rock core sample, comprising:
a flow line with connectors that provide for sealable coupling to a fluid inlet port and fluid outlet port of a cell that holds the rock core sample within an interior chamber of the cell, wherein the flow line includes an electrically-controlled first isolation valve operably disposed upstream of the cell, an electrically-controlled second isolation valve operably disposed downstream of the cell, and a pressure sensor for measuring fluid pressure in the flow line;
an electrically-controlled heater block for heating the cell;
an electrically-controlled pump, fluidly coupled to the flow line, for supplying a liquid phase solvent under pressure to the flow line; and
a controller that is operably coupled to the first and second isolation valves, the pressure sensor, the pump and the heater block,
wherein the controller is configured to control operation of the first and second isolation valves, the pump and the heater block during at least one interval of time in order to soak the rock core sample supported within the interior chamber of the cell with a liquid phase solvent pressurized above ambient pressure at a temperature elevated above ambient temperature without any flow of the liquid phase solvent into, through, and out of the interior chamber of the cell; and
wherein the controller is configured to control operation of the second isolation valve after expiration of the interval of time to allow the liquid phase solvent to drain from the cell.

17. An apparatus according to claim 16, wherein the cell is configured to allow for fluid flow into the interior chamber via the fluid inlet, through the interior chamber, and out of the interior chamber via the fluid outlet.

18. An apparatus according to claim 16, wherein the controller controls at least one operational parameter related to soaking the rock core sample, wherein the at least one operational parameter is selected from the group consisting of i) the duration of the interval of time, ii) pressure of the liquid phase solvent during the interval of time, and iii) temperature of the cell during the interval of time.

19. An apparatus according to claim 18, further comprising user input means for interacting with the control to specify the at least one operational parameter.

20. An apparatus according to claim 16, wherein the apparatus includes a plurality of flow lines for processing a plurality of rock core samples in parallel to allow for soaking of the plurality rock core samples supported within the interior chambers of respective cells during the at least one interval of time.

21. An apparatus according to claim 16, wherein the at least one interval of time has a cumulative duration less than 10 minutes.

22. An apparatus according to claim 16, wherein the pressure of the liquid phase solvent during the interval of time is between 80 bar and 100 bar.

23. An apparatus according to claim 16, wherein the temperature of the cell during the interval of time is at or near 150° C.
